(19) United States
(12) Patent Application Publication
(10) Pub. No.: US 2002/0085907 A1
(43) Pub. Date: Jul. 4, 2002

(54) Self-aligning and floating apparatus for an automatic tester

(76) Inventors: Edward C.M. Chang, San Francisco, CA (US); Derek S. Chang, San Francisco, CA (US); Deirdre McGlashan, San Francisco, CA (US)

Correspondence Address: Jason Z. Lin, Post Office Box 3318, Saratoga, CA, 95070, US

(21) Appl. No.: 09/753,731

(22) Filed: Jan. 2, 2001

(51) Int. Cl. B25J 1/00

(52) U.S. Cl. 414/754

(57) ABSTRACT

An apparatus includes coupling and supporting devices for floating and positioning a fixture to dock with another fixture. A coupling device is mounted on the fixture and coupled to an immediate plate using ball bearings to provide movements in X-Y directions as well as angular movements. The supporting device comprises a ball joint mounted between the immediate plate and a supporting plate to allow the fixture to be tilted. Sliding rods and a hinge are mounted on the supporting plate so that the fixture can be flipped over 180 degrees. Springs can be used instead of a ball joint. Sliding tracks and plates can also be used to provide movements in the X-Y directions. Guide devices each having a male guide member with a cone shaped head and a matched female guide member with a cone shaped void are used to guide the fixtures into positions for docking.

### FIELD OF THE INVENTION

The present invention generally relates to an apparatus for docking two fixtures, and more specifically to an apparatus that provides self aligning and floating mechanism for an automatic test equipment (ATE) to dock a fixture with another fixture.

### BACKGROUND OF THE INVENTION

In general, it is very difficult to dock two fixtures together precisely if they are supported by different structures that have no mechanical relationship with each other. Even with guide pins to guide the two fixtures to meet together, the guide pins often force the two fixtures to meet by force. This results in bending the guide pins, distorting the fixtures or distorting the structures which hold the fixtures.

In the industry of integrated circuit manufacturing, an ATE system is used to test the functionality of an integrated circuit device. A test head is provided in an ATE system to interface a handler for packaged testing as well as a prober for wafer testing. In a conventional ATE system, the entire test head 102 is mounted on a manipulator 101 as shown in FIG. 1A, or the test head is integrated to the body of the tester 103 and the entire tester is mounted on a manipulator 101 as shown in FIG. 1B.

A handler above the test head or a prober below the test head must be docked onto the test head before a test can be started. FIG. 2 illustrates how two fixtures such as a test head 203 and a handler 204 dock together with the aid of guide pins 201. Notice that the guide pins 201 are straight. The guide pins 201 and guide holes 202 fit very tightly together so that the two fixtures can dock precisely.

The test head and the handler or prober are heavy objects. The manipulator 101 as shown in FIG. 1 allows the test head to be adjusted manually to position as precisely as humanly possible before docking to the prober or the handler. Because the precision is beyond the capability of a human eye, and the operator's visibility is often restricted by both massive objects, the guide pins frequently force the arms of the manipulator to bend in order to dock together. The procedure is very awkward and time consuming.

With reference to FIG. 1A, a first track 104 allows the test head 102 to move in and out and lock by a first lock 114 after it is positioned manually. A second track 105 allows the test head 102 to move left and right and lock by a second lock 115. The rotating disc 106 at the center of the manipulator 101 allows the test head 102 to be rotated 180 degrees or more and lock by a third lock 116. The counter weight 107 and a fourth lock 117 allows the test head to move up and down easily.

The left hand side of FIG. 1A is the front view and the right hand side of FIG. 1A is the side view. Notice that there is an empty space underneath the test head 102. In FIG. 1B, the test head is integrated with the tester 103 and the entire unit is mounted on the manipulator 101. The movements of the tester 103 are the same as in FIG. 1A. One drawback with the fixture in FIG. 1B is that the tester 103 is growing bigger as more functions are added into the tester.

Two movements are missing in the conventional design illustrated in FIGS. 1A and 1B. One is an angular movement of the test head 102 other than moving the entire manipulator by wheels. The other is a tilt movement for adjusting the test head 102 if the two fixtures to be docked together are not perfectly parallel. The only way to dock these two fixtures is to bend their arms by force.

### SUMMARY OF THE INVENTION

This invention has been made to overcome the aforementioned drawbacks of time consuming and tedious procedures in docking two fixtures. The primary object is to provide a self-aligning and floating apparatus for a fixture to dock with another fixture. Accordingly, the apparatus of this invention comprises a ball joint mounted between an immediate plate and a supporting plate. The immediate plate is secured to a fixture and the supporting plate is seated on top of a table. The ball joint allows the fixture to be tilted and also provides angular movements. Therefore, the fixture is floating from the supporting plate.

Another object of the invention is to provide the floating fixture with movements in X-Y as well as angular directions. In the self-aligning and floating apparatus, ball bearings are used to secure and couple the immediate plate to the floating fixture. The ball bearings allow the fixture to move in and out as well as left and right and angularly.

It is also an object of the invention to provide an apparatus that may be flipped over 180 degrees. The supporting plate seated on top of a table is mounted with a hinge and two sliding rods. By means of the sliding rods and the hinge, the entire fixture along with the supporting plate can be flipped over 180 degrees around the hinge.

In the present invention, springs may also be used instead of a ball joint for the self-aligning and floating apparatus. The two sliding rods are moved independently to compress each spring separately to accommodate some tilt movements of the floating fixture. The springs may be mounted above or below the supporting plate. A ball joint may also be used together with springs in certain conditions.

A further object of the invention is to provide a guide device that comprises a male guide member with a cone shaped head and a matched female guide member with a cone shaped void for docking the floating fixture with another fixture. By attaching one of the matched guide members to the floating fixture and the other matched guide member to another fixture, the cone shaped mechanism in the guide device leads and docks the two fixtures smoothly and precisely with the assistance of the self-aligning and floating apparatus.

It is yet another object of the invention to provide the floating fixture with movements in X-Y directions by means of sliding tracks instead of ball bearings. Accordingly, a first sliding track is mounted on the supporting plate to allow a second sliding track to slide in an X-direction. A sliding plate is then mounted on the second sliding track to slide in a Y-direction. The sliding plate is coupled to the fixture by means of ball bearings to allow an angular movement. A ball joint instead of ball bearings may also be used to provide the angular movement.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1A shows the front and side views of a conventional ATE system having a test head mounted on a manipulator with tracks for moving the test head and a rotating disk for rotating the test head.

FIG. 1B shows the front and side views of a conventional ATE system in which an entire small tester is mounted on a manipulator.

FIG. 2 shows the conventional method for positioning two fixtures manually with the assistance of guide pins and holes.

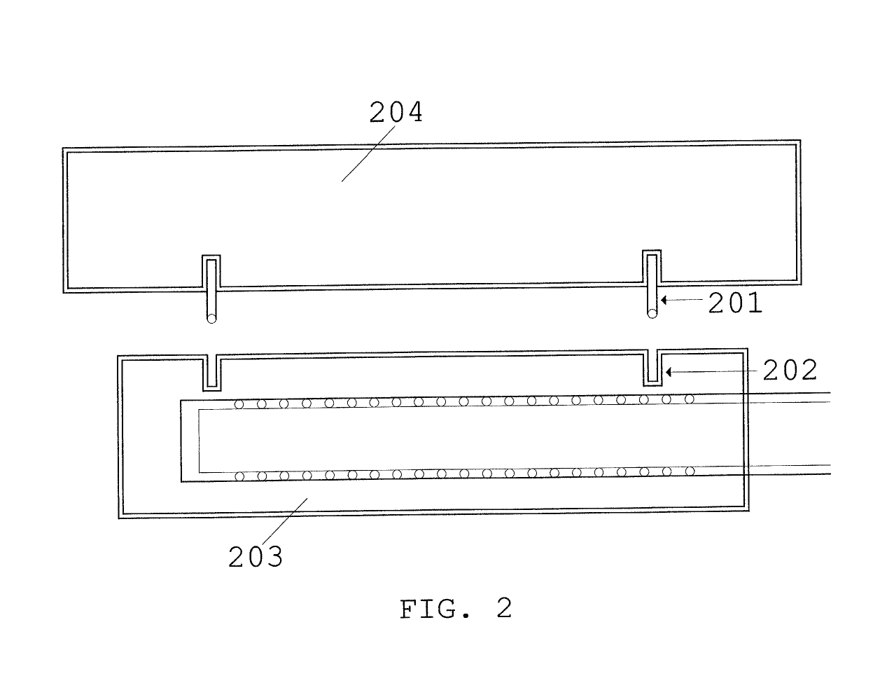

FIG. 3A shows a front view of an embodiment in which a fixture is coupled to a self-aligning and floating apparatus having a ball joint according to the present invention.

FIG. 3B shows the top view and front view of the self-aligning and floating apparatus with a ball joint according to the invention.

FIG. 3C shows a front view of another embodiment in which a fixture is coupled to a self-aligning and floating apparatus having springs instead of a ball joint according to the present invention.

FIG. 3D shows a side view of the embodiment illustrated in FIG. 3C.

FIG. 3E shows that the floating fixture in the embodiment illustrated in FIG. 3C is flipped up 90 degrees.

FIG. 3F shows the front view of an alternative embodiment in which the design of the self-aligning and floating apparatus has been simplified and springs are placed between the immediate plate and the supporting plate.

FIG. 4A shows that the floating fixture in the embodiment illustrated in FIG. 3A is moved towards left.

FIG. 4B shows an example of implementing the mechanism for flipping the test head by means of gears.

FIG. 5 shows that two fixtures are positioned for docking with assistance of guide devices having matched male and female guide members with cone shaped structures according to the present invention.

FIG. 6 shows the side views of the matched male and female guide members with protruded portions to prevent them from turning according to the present invention.

FIG. 7 shows that two fixtures are docked together.

FIG. 8 shows that the floating fixture in the embodiment illustrated in FIG. 3C is flipped over 180 degrees and docked with another fixture.

FIG. 9A shows another embodiment in which two sliding tracks and a sliding plate are used in the self-aligning and floating apparatus to provide movements in X-Y directions and ball bearings are used for angular movements according to the present invention.

FIG. 9B shows an embodiment similar to that illustrated in FIG. 9A except that a ball joint is used to replace the ball bearings for angular movements.

FIG. 10 shows an embodiment similar to that illustrated in FIG. 3C except that the springs extend into a drawer of the table and sliding tracks are provided for sliding the floating fixture towards one side horizontally.

### DETAILED DESCRIPTION OF THE INVENTION

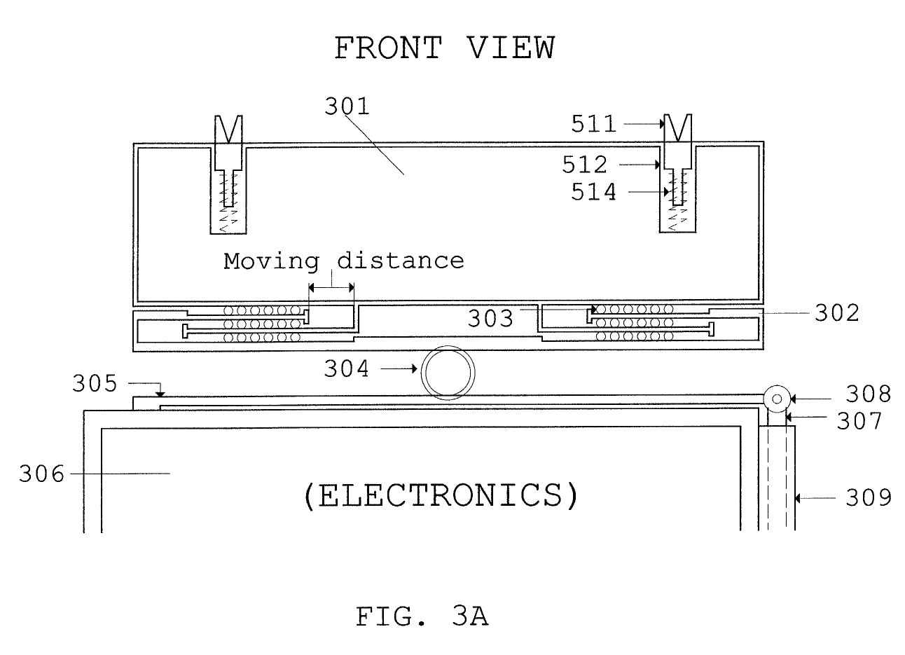

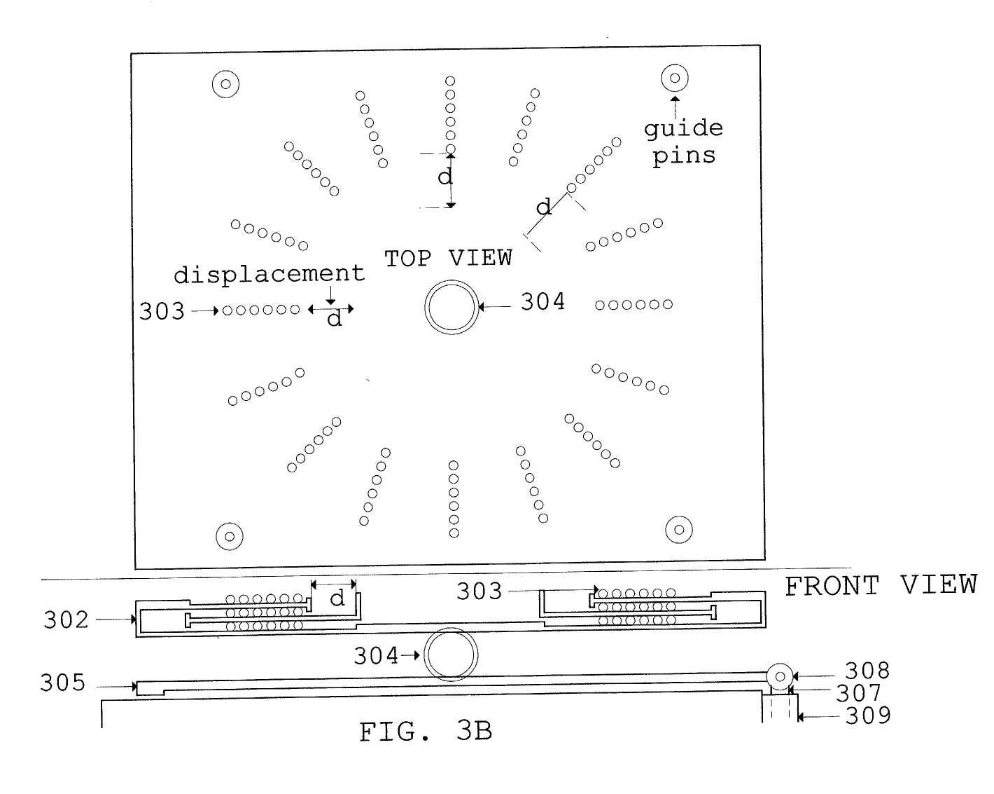

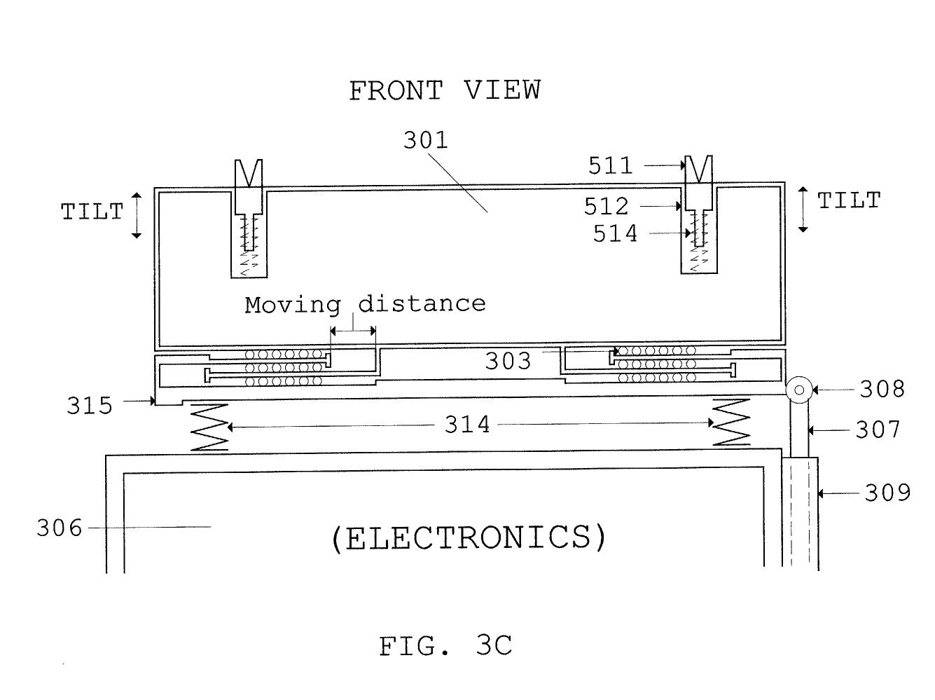

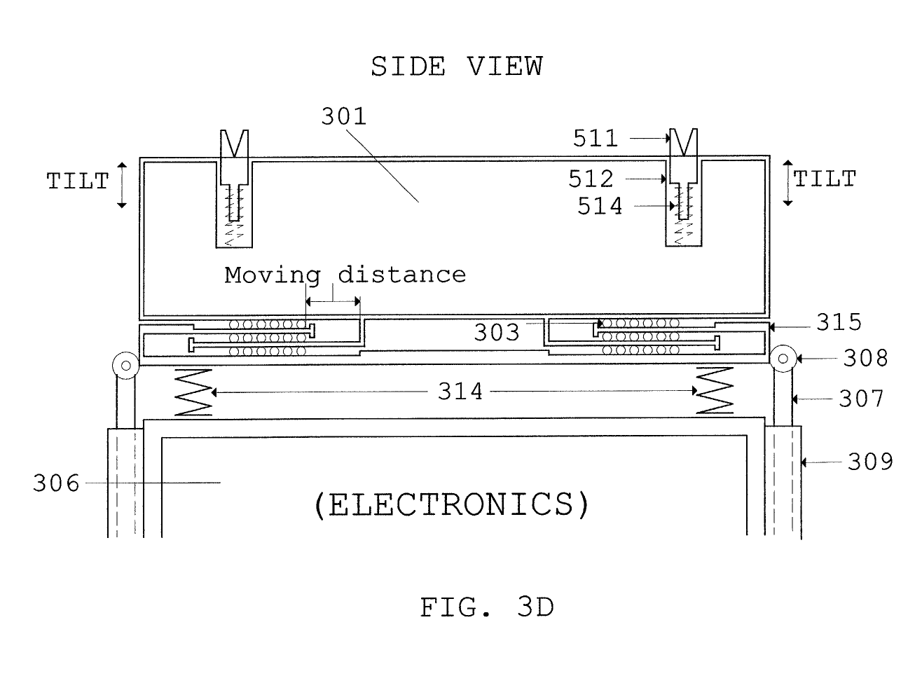

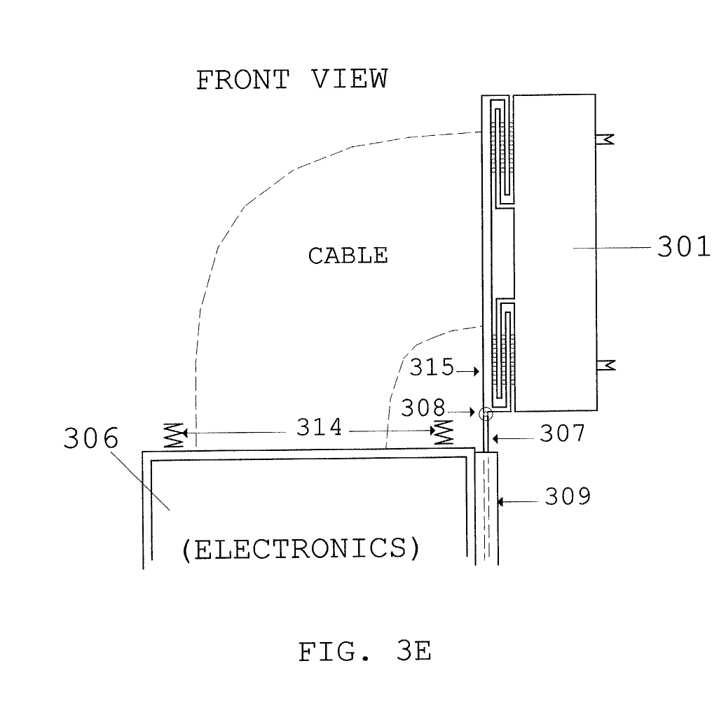

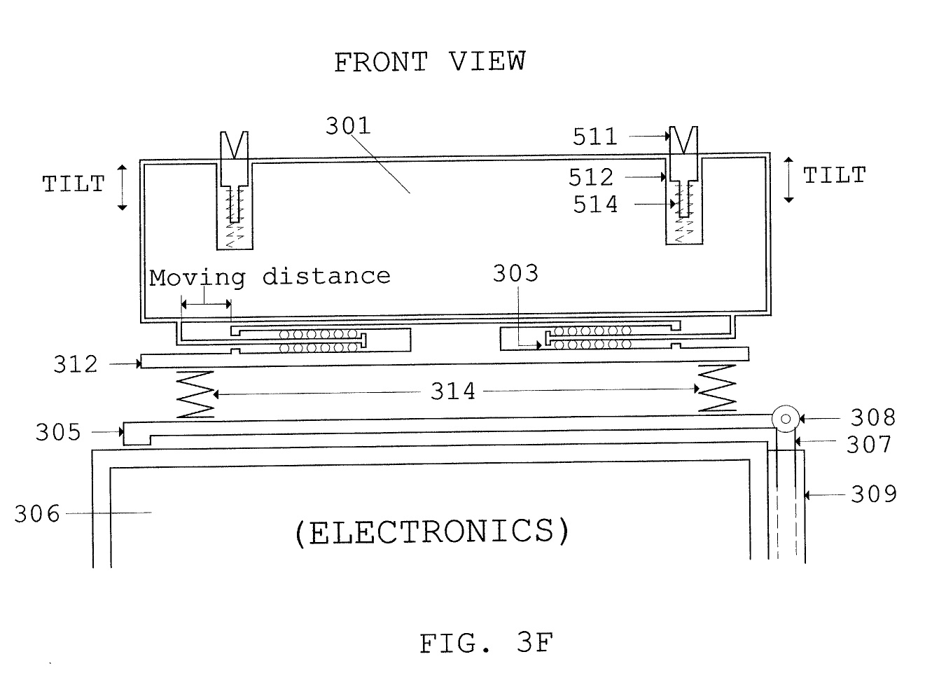

FIG. 3A shows the front view of an embodiment of the self-aligning and floating fixture according to the present invention. A fixture 301 is coupled to an immediate plate 302 by small ball bearings 303 that allow the fixture 301 to be moved freely in X-Y directions as well as angular directions. The immediate plate 302 is mounted on one side of a ball joint 304 that serves as a supporting device. The other side of the ball joint 304 is mounted on a supporting plate 305. This allows the fixture 301 to be tilted in all directions as well as provides angular movements. Consequently, the entire fixture 301 is floating from the supporting plate 305. FIG. 3B is the top view of FIG. 3A.

The self-aligning and floating apparatus of this invention can be used generally in many different areas. One important application is to overcome the drawbacks of a conventional ATE system in which a test head has to be docked with a handler or a prober as discussed in the background of the invention. The following description uses an ATE system as an example for illustration. The fixture 301 represents a test head of an ATE.

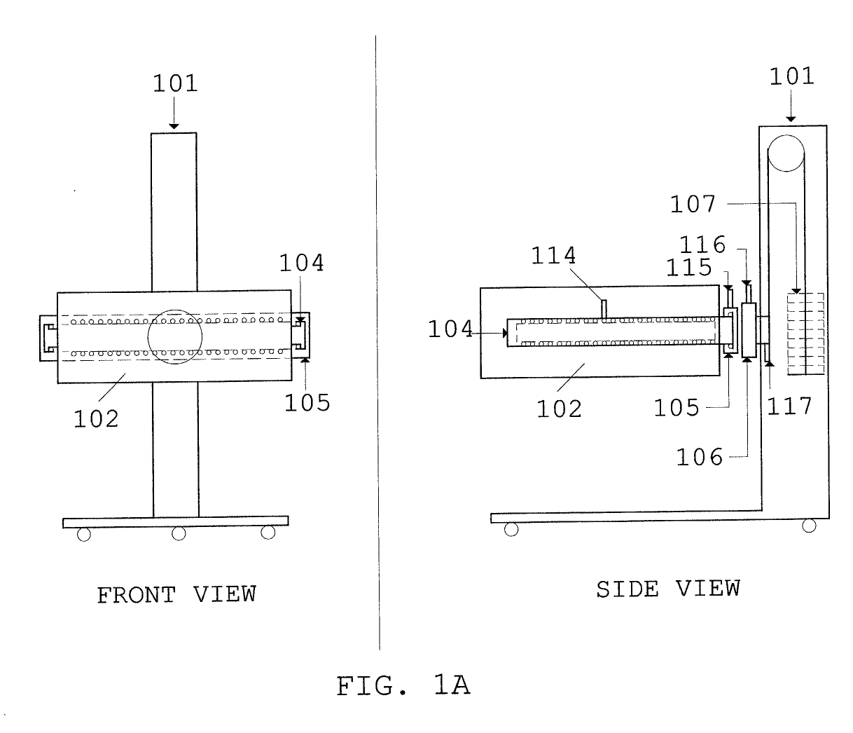

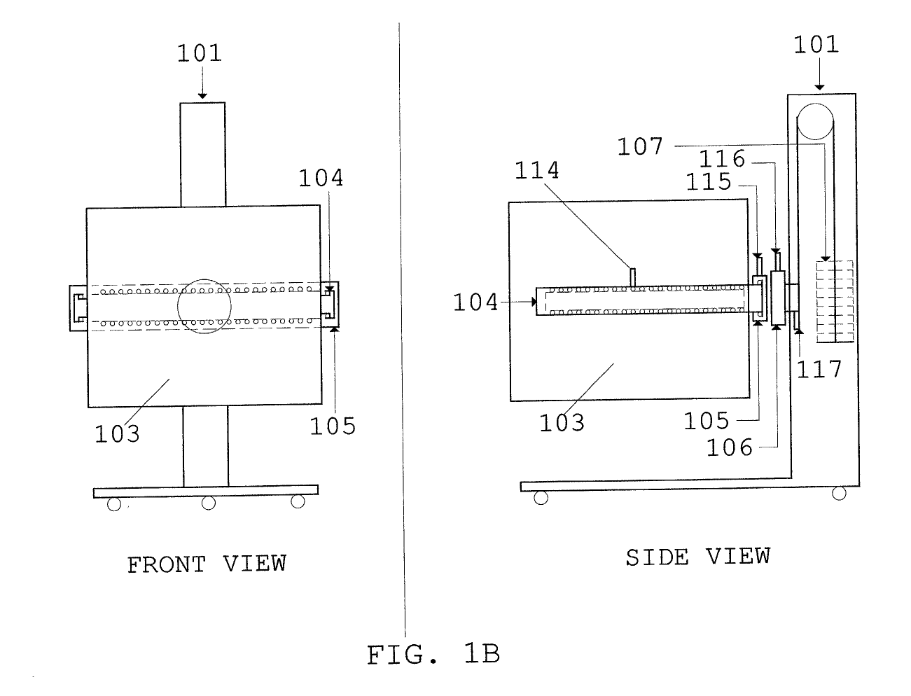

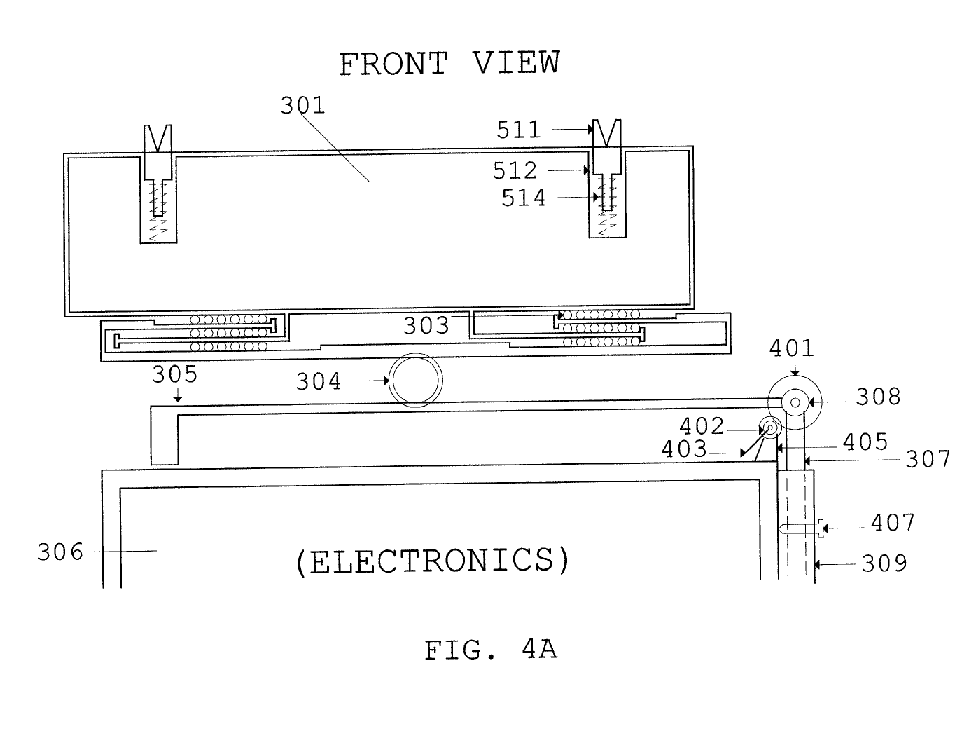

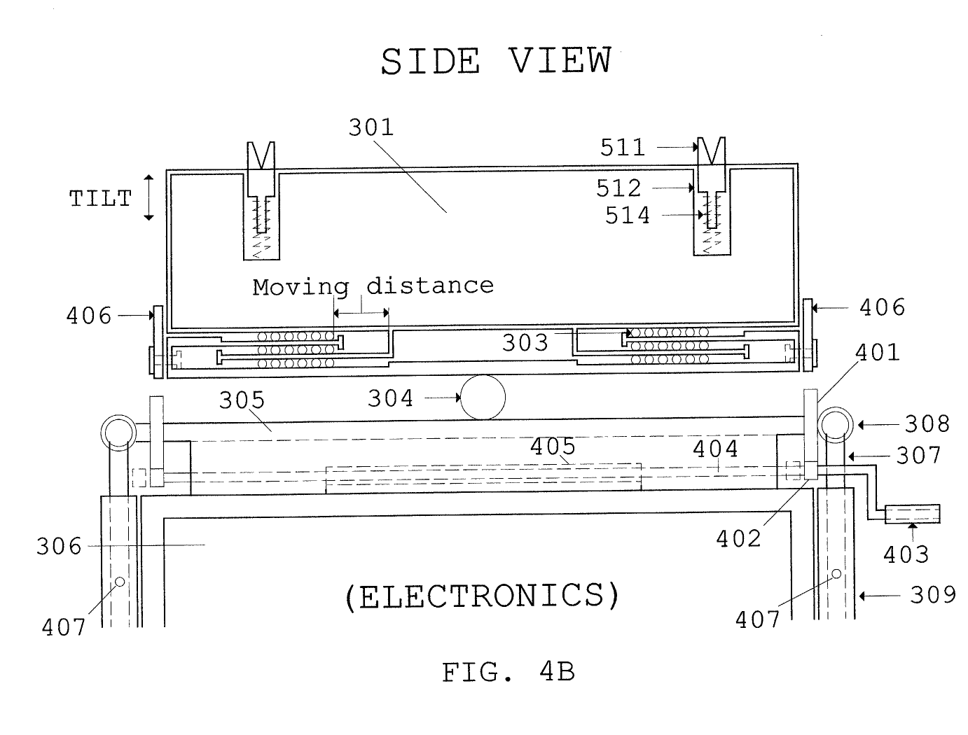

The supporting plate 305 sits on top of a table 306 and there are electronics underneath the table 306. In the present invention, the space underneath the test head 301 is utilized as compared to the conventional fixture in which the space is wasted. The right side of the supporting plate 305 is mounted on sliding rods 307 with a hinge 308 to allow the entire assembly to be flipped over 180 degrees. This eliminates the need of counterbalance weight as shown in FIG. 1 and the entire mechanism is much less in weight without a manipulator. Also the sliding rods 307 are moved independently to accommodate some tilt movements. FIG. 4A shows the test head 301 has moved all the way to the left.

As mentioned earlier, an object of the invention is to provide a mechanism for flipping over the test head 180 degrees. There are many ways to implement the flipping mechanism that is shown as a hinge 308 in FIGS. 3A-3F. For a low pin count test head, the test head can be flipped over by hand. For a large pin count test head, it is necessary to use a large gear 401 that is attached to the supporting plate 305 as illustrated in FIGS. 4A and 4B. A small gear 402 is mounted on the table 306 and coupled to the large gear 401.

The gear ratio between large and small gears is designed to allow the gears to be cranked by hand. There is a toggling fork (not shown) to prevent the gear from running away if the hand slips as well as to regulate the cranking speed. FIG. 4B shows that the small gear 402 can be disconnected from the large gear 401 after the flipped position is reached. This allows the two ball joints at the end of the sliding rods 307 to move freely. In fact, there are not many movements that the sliding rods 307 can make independently because the supporting plate 305 already determines the position of the ball joints. The only movement that is allowed is the free play of the sliding rods 307 and the metal tubes 309. The majority of the movement is accomplished by the ball joint 304 or springs.

There are pins 407 to lock the sliding rods 307 in position as well as locking plates 406 to prevent the test head 301 from moving before the flipping action starts as shown in FIG. 4B. After the inverted position is reached, the locking plates 406 can be turned to the side to let the test head 301 float freely, and the locking pins 407 at the sliding rods 307 are removed. A handle 403 is connected to the small gear 402 for cranking. A shaft 404 and a shaft support 405 are also illustrated in FIG. 4B to show how the supporting plate 305, the gears 401, 402 and the handle 403 may be assembled together.

In another embodiment of the invention, springs 314 are used instead of the ball joint 304 as the supporting device for the tilting action because the individual spring can be compressed separately as shown in FIG. 3C. The springs 314 also alleviate the excess pressure applied to two surfaces when two fixtures are docked together. In the embodiment, the immediate plate 302 and the supporting plate 305 of FIG. 3A has been integrated as the supporting plate 315 as illustrated. The springs 314 are put underneath the supporting plate 315.

FIG. 3D shows the side view of FIG. 3C. FIG. 3E shows that the test head 301 is being flipped up to a 90 degree position. A cable connecting the electronics underneath to the test head is also shown. The two sliding rods 307 slide along the metal tubes 309 individually. The different height of the two rods 307 together with the springs 314 provides all the tilting action.

In the present invention, the self-aligning and floating apparatus may be modified in many different ways without departing from the gist of this invention. Each embodiment illustrated in the accompanied drawings may be shown with a particular configuration. However, modifications and combinations of different parts in the apparatus can be derived based on the principle of the invention by a person of ordinary skill in the art.

With reference to FIG. 3F, an example of modifying the apparatus is illustrated. In the figure, the structure of the immediate plate 312 and the associated structures for small ball bearings 303 have been simplified as compared to FIG. 3D. However, in this design the immediate plate 312 and the supporting plate 305 are separated and the springs 314 are put above the supporting plate 305.

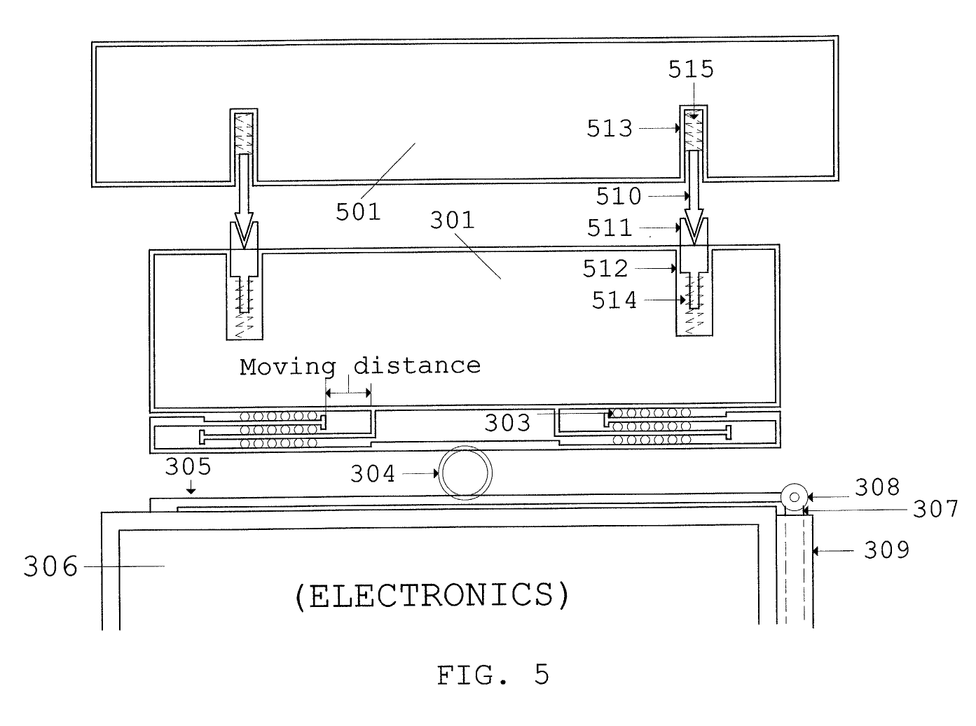

According to this invention, a new guide device is provided to improve the docking action between two fixtures. As shown in FIG. 5, the guide device comprises a male guide member 510 with a cone shaped head, and a matched female guide member 511 with a cone shaped void. The male and female guide members each can be located on either the test head 301 or the handler 501. Cylindrical holes 512, 513 are formed on the test head 301 as well as the handler 501. Springs 514 and 515 are mounted within the holes for retaining the guide members.

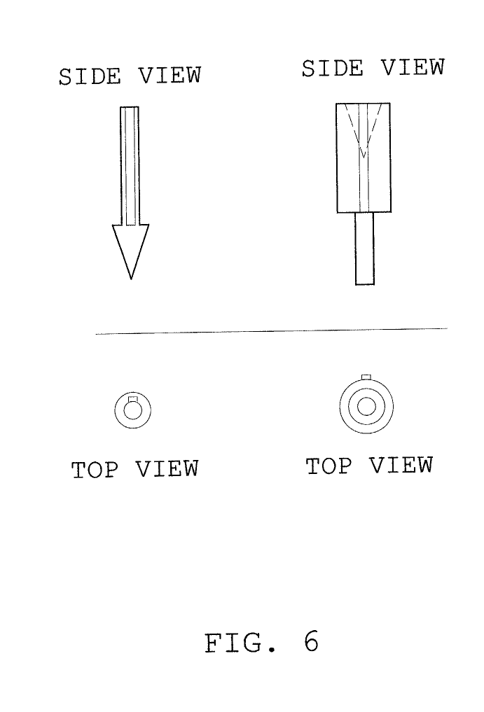

FIG. 5 shows the two fixtures are positioned for docking. Once the male guide members are moved within the cone shaped voids of the female guide members, either the handler 501 is lowered or the test head 301 is moved up. The test head 301 floats towards the handler 501, guided by the guide members that are received and supported by the springs 514, 515 within the cylindrical holes 512, 513. FIG. 6 shows the side and top views of the male and female guide members. They both have protruded portions to prevent them from turning. This also maintains the repeatability every time when they are docked together.

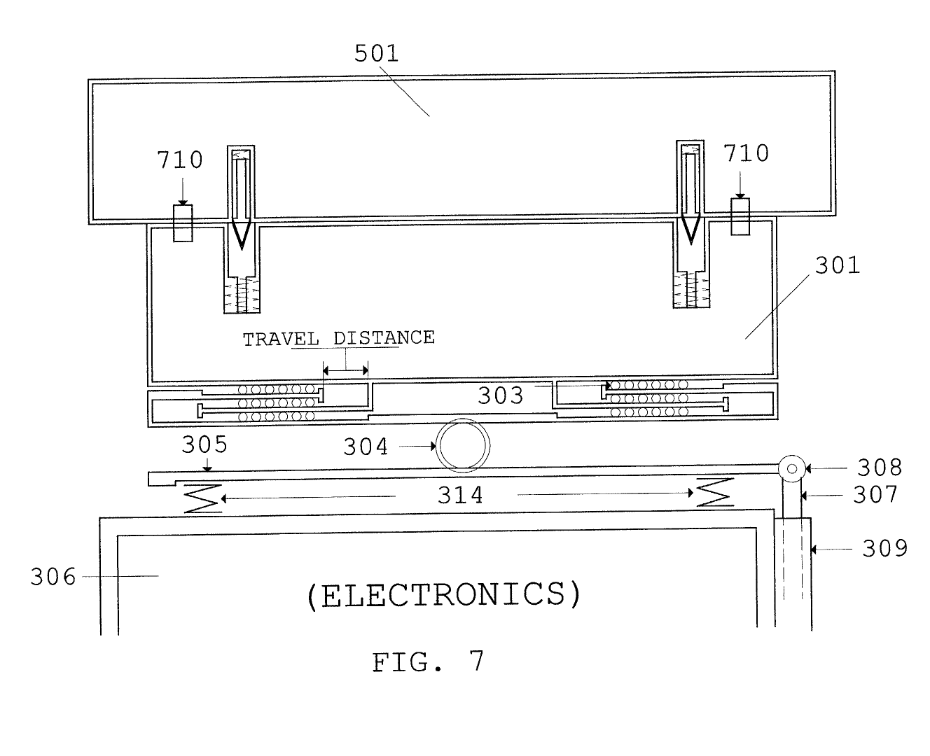

FIG. 7 shows the test head 301 and the handler 501 are docked together. Because of the mechanical movement of the handler 501, it is recommended that locks 710 be used to lock the two fixtures mechanically rigid together after docking. For more smooth movement, a ball joint 304 and springs 314 can be used together as shown in FIG. 7.

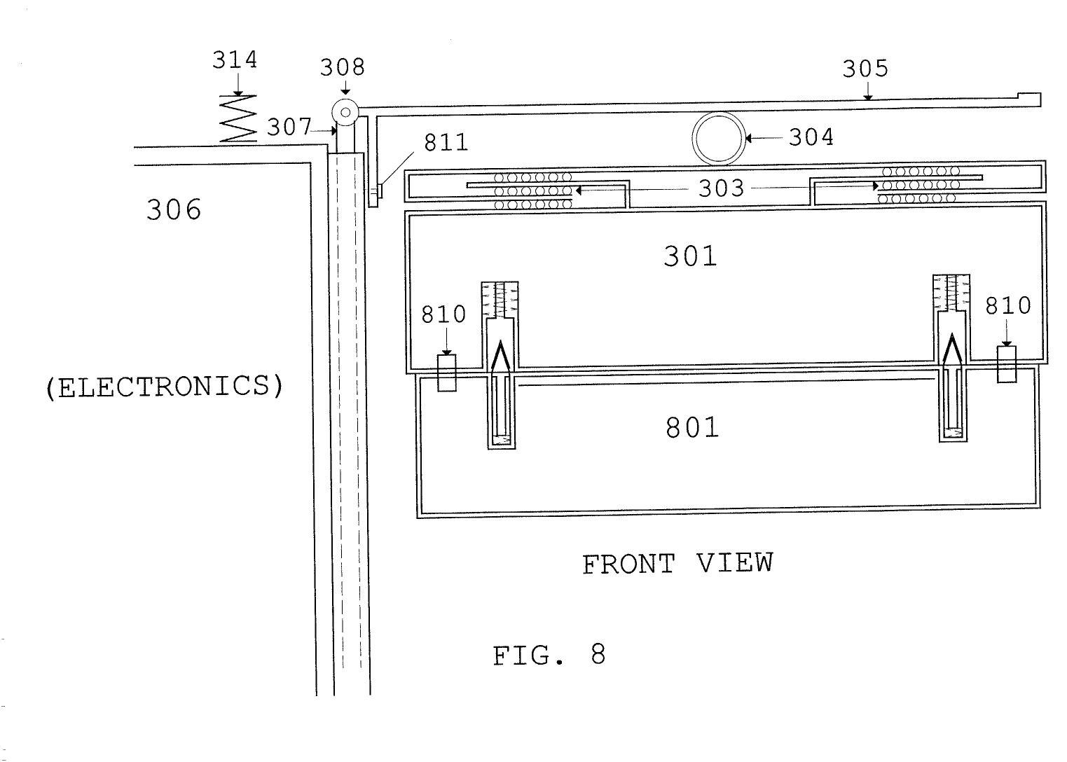

FIG. 8 shows the test head 301 is flipped over 180 degrees to dock with a prober 801. When the two fixtures are making contact, the two sliding rods 307 move up to allow the test head 301 to sit on top of the prober 801. Since the sliding rods 307 can move up and down independently, they work together with the hinge 308 on the supporting plate 305 to allow the tilting action to accommodate the horizontal differences between the two fixtures. Therefore, the surfaces of the test head 301 and the prober 801 match perfectly. Again locks 810 mechanically lock the two fixtures together to prevent any vibration due to the mechanical movements inside the fixtures. A level adjustment screw 811 is used to adjust the level of the fixtures.

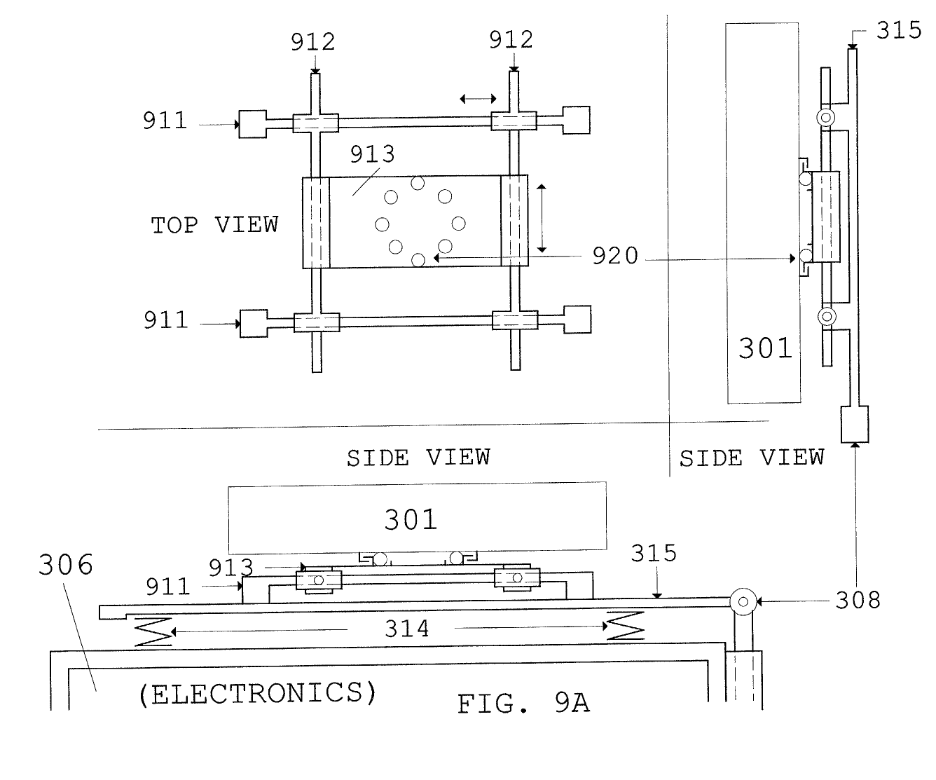

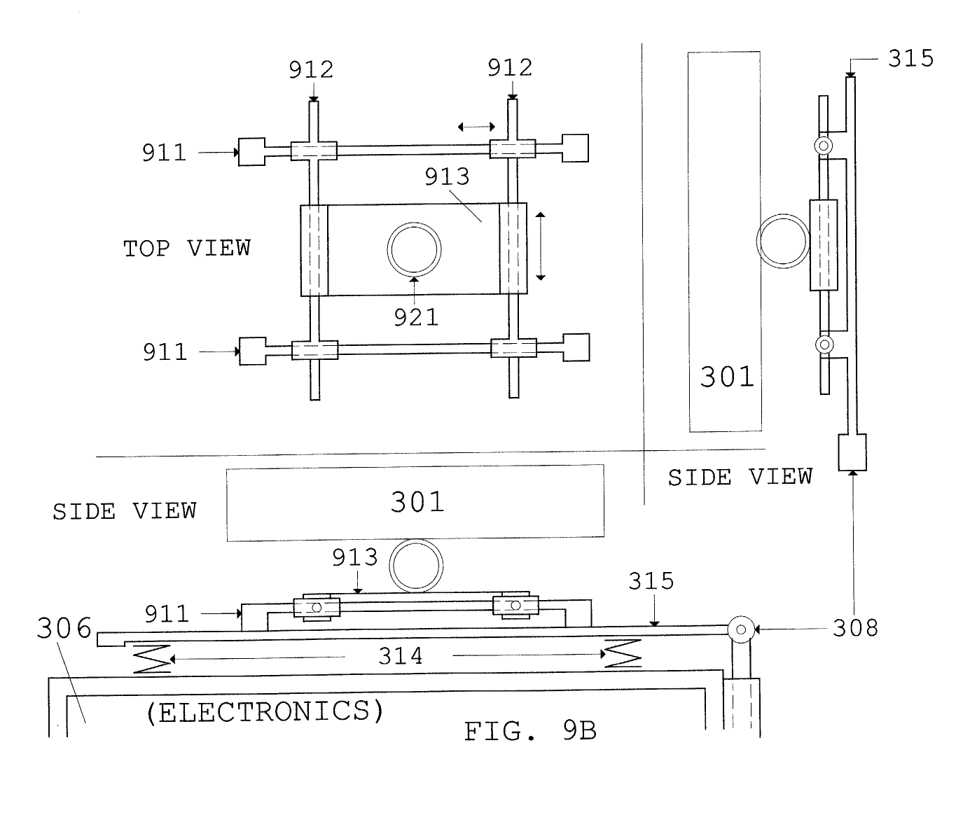

Instead of using small ball bearings to support the test head 301 as shown on previous figures, a sliding and rotating device having sliding tracks can be used to make the test head 301 float in X-Y directions as shown in FIG. 9A. A pair of first sliding tracks 911 are mounted on the supporting plate 315 to allow a pair of second sliding tracks 912 to move along the first sliding tracks 911. A sliding plate 913 is moving along the second sliding tracks 912. There are ball bearings 920 coupled between the sliding plate 913 and the test head 301 to allow the angular movement.

FIG. 9A shows the top view, a side view from X-direction and another side view from Y-direction. The entire mechanism allows the test head 301 to have X, Y and angular movements. Again, the springs 314 allow the test head surface to make contact with another fixture surface even if both surfaces are not in parallel. FIG. 9B shows another embodiment in which the same mechanism is used for X-Y movements as in FIG. 9A but a ball joint 921 is used in the sliding and rotating device for an angular movement instead of ball bearings.

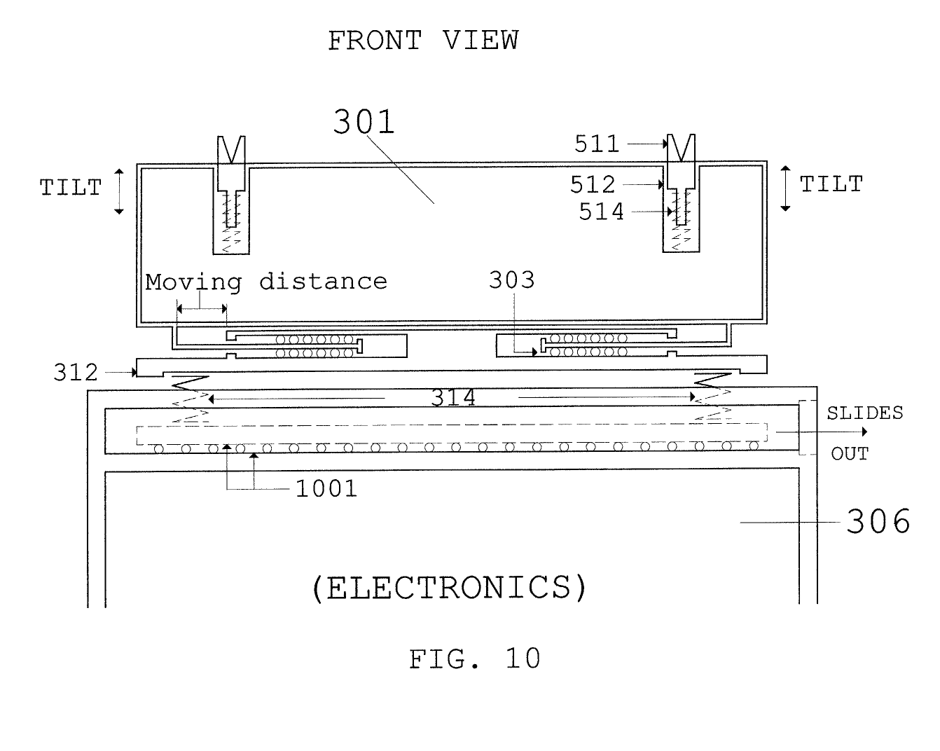

According to another embodiment of the invention, the springs 314, which are coupled with the supporting plate 312, extend into a drawer inside the table 306 as shown in FIG. 10. Sliding tracks 1001 coupled to the springs 314 are formed in the drawer. The entire assembly including the test head 301 can be pulled out and slid towards one side instead of being flipped over by 180 degrees. After the test head 301 is pulled aside, it can then be rotated 180 degrees to face down for docking with another fixture.

As described above, many minor modifications can be made to the embodiments of the invention. For example, springs can be used to replace a ball joint for the floating mechanism as illustrated in FIGS. 3A-3F. A ball joint may also be used to replace ball bearings for angular movements as illustrated by FIGS. 9A and 9B. In addition, sliding tracks instead of ball bearings may be used for movements in X-Y directions. Many combinations of the modifications are also possible.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for supporting and floating a first fixture, said apparatus comprising:
an immediate plate;
a coupling device above said immediate plate and coupled with said immediate plate by means of a sliding and rotating device;
a supporting plate below said immediate plate; and
a supporting device mounted between said supporting plate and said immediate plate, said supporting device allowing said first fixture to be tilted when said coupling device is mounted on said first fixture.

2. The apparatus as claimed in claim 1, wherein said supporting device comprises a plurality of springs.

3. The apparatus as claimed in claim 1, wherein said supporting device comprises a ball joint.

4. The apparatus as claimed in claim 3, further comprising a plurality of springs mounted on said supporting plate from underneath.

5. The apparatus as claimed in claim 1, wherein said sliding and rotating device comprises a plurality of ball bearings coupling said immediate plate to said coupling device.

6. The apparatus as claimed in claim 1, wherein said sliding and rotating device comprises:
at least one horizontal sliding track mounted on said immediate plate;
at least one vertical sliding track mounted on said at least one horizontal sliding track;
a sliding plate mounted on said at least one vertical sliding track; and
a plurality of ball bearings coupling said sliding plate to said coupling device.

7. The apparatus as claimed in claim 1, wherein said sliding and rotating device comprises:
at least one horizontal sliding track mounted on said immediate plate;
at least one vertical sliding track mounted on said at least one horizontal sliding track;
a sliding plate mounted on said at least one vertical sliding track; and
a ball joint coupling said sliding plate to said coupling device.

8. The apparatus as claimed in claim 1, further having a flipping mechanism and a plurality of sliding rods mounted on an edge of said supporting plate for hingedly flipping over said supporting plate and said first fixture supported thereon by 180 degrees.

9. The apparatus as claimed in claim 1, further comprising a plurality of guide devices for guiding said first fixture to a position for docking with a second fixture.

10. The apparatus as claimed in claim 9, wherein each of said guide devices comprises a male guide member having a cone shaped head and a matched female member having a cone shaped void, and one of said guide members is attached to said first fixture and the other of said guide members is attached to said second fixture.

11. The apparatus as claimed in claim 10, wherein each guide member is attached and received in a hole formed on said first or second fixture by means of a spring member mounted within the hole.

12. The apparatus as claimed in claim 10, wherein each guide member further has a protruded portion to prevent it from turning.

13. An automatic tester comprising the apparatus as claimed in claim 1 and a plurality of guide devices for guiding said first fixture to a position for docking with a second fixture, each of said guide devices comprising a male guide member having a cone shaped head and a matched female member having a cone shaped void; wherein said first fixture is a test head, said coupling device of said apparatus is mounted on said test head, said second fixture is a handler, and one of said guide members is attached to said test head and the other of said guide members is attached to said handler.

14. The automatic tester as claimed in claim 13, further having a flipping mechanism and a plurality of sliding rods mounted on an edge of said supporting plate for hingedly flipping over said supporting plate and said test head supported thereon by 180 degrees.

15. An apparatus for supporting and floating a first fixture, said apparatus comprising:
a supporting plate;
a coupling device above said supporting plate and coupled with said supporting plate by means of a sliding and rotating device; and
a plurality of springs mounted on said supporting plate from underneath;
wherein said coupling device is mounted on said first fixture, and said plurality of springs allow said first fixture to be tilted.

16. The apparatus as claimed in claim 15, wherein said sliding and rotating device comprises a plurality of ball bearings coupling said supporting plate to said coupling device.

17. The apparatus as claimed in claim 15, wherein said sliding and rotating device comprises:
at least one horizontal sliding track mounted on said supporting plate;
at least one vertical sliding track mounted on said at least one horizontal sliding track;
a sliding plate mounted on said at least one vertical sliding track; and
a plurality of ball bearings coupling said sliding plate to said coupling device.

18. The apparatus as claimed in claim 15, wherein said sliding and rotating device comprises:
at least one horizontal sliding track mounted on said supporting plate;
at least one vertical sliding track mounted on said at least one horizontal sliding track;
a sliding plate mounted on said at least one vertical sliding track; and
a ball joint coupling said sliding plate to said coupling device.

19. The apparatus as claimed in claim 15, further having a flipping mechanism and a plurality of sliding rods mounted on an edge of said supporting plate for hingedly flipping over said supporting plate and said first fixture supported thereon by 180 degrees.

20. The apparatus as claimed in claim 15, further comprising a plurality of guide devices for guiding said first fixture to a position for docking with a second fixture.

21. The apparatus as claimed in claim 20, wherein each of said guide devices comprises a male guide member having a cone shaped head and a matched female member having a cone shaped void, and one of said guide members is attached to said first fixture and the other of said guide members is attached to said second fixture.

22. The apparatus as claimed in claim 21, wherein each guide member is attached and received in a hole formed on said first or second fixture by means of a spring member mounted within the hole.

23. The apparatus as claimed in claim 21, wherein each guide member further has a protruded portion to prevent it from turning.

24. An automatic tester comprising the apparatus as claimed in claim 15 and a plurality of guide devices for guiding said first fixture to a position for docking with a second fixture, each of said guide devices comprising a male guide member having a cone shaped head and a matched female member having a cone shaped void; wherein said first fixture is a test head, said coupling device of said apparatus is mounted on said test head, said second fixture is a handler, and one of said guide members is attached to said test head and the other of said guide members is attached to said handler.

25. The automatic tester as claimed in claim 24, further having a flipping mechanism and a plurality of sliding rods mounted on an edge of said supporting plate for hingedly flipping over said supporting plate and said test head supported thereon by 180 degrees.

26. The automatic tester as claimed in claim 24, wherein said plurality of springs of said apparatus extend into a drawer formed near a table top and are coupled to a plurality of sliding tracks mounted in said drawer for allowing said test head to slide towards one side.
